(19) United States
(12) Patent Application Publication
(10) Pub. No.: US 2026/0272137 A1
(43) Pub. Date: Sep. 17, 2026

(54) HEATER ASSEMBLY FOR A HAIRCARE APPLIANCE

(71) Applicant: Dyson Technology Limited, Malmesbury, Wiltshire (GB)

(72) Inventors: Gavin John GALLIGAN, Gloucester (GB); James Michael Crosby DURRANT, Swindon (GB)

(21) Appl. No.: 18/872,300

(22) PCT Filed: Jun. 7, 2023
(86) PCT No.: PCT/IB2023/055885

§ 371 Date: Dec. 6, 2024

(30) Foreign Application Priority Data
Jun. 8, 2022 (GB) 2208381.0

(51) Int. Cl. A45D 20/12; G01K 1/02; H05B 3/03

(52) U.S. Cl. CPC A45D 20/12; G01K 1/026; H05B 3/03

(57) ABSTRACT

A heater assembly for a haircare appliance is described. The heater assembly comprises first and second frames arranged along a curved path to define an airflow path, a first resistive track supported by the first frame such that the first resistive track is held within the airflow path, and a second resistive track supported by the second frame such that the second resistive track is held within the airflow path.

### FIELD OF THE INVENTION

The present invention relates to a heater assembly for a haircare appliance.

### BACKGROUND OF THE INVENTION

A haircare appliance may utilise an airflow generator to generate an airflow through the haircare appliance, and a heater assembly to heat the airflow such that a heated airflow may be emitted from the haircare appliance. The heater airflow may be used by a user of the haircare appliance to style hair.

### SUMMARY OF THE INVENTION

A first aspect of the present invention provides a heater assembly for a haircare appliance, the heater assembly comprising first and second frames arranged along a curved path to define an airflow path, a first resistive track supported by the first frame such that the first resistive track is held within the airflow path, and a second resistive track supported by the second frame such that the second resistive track is held within the airflow path.

Arranging the frames, and thereby the resistive tracks, along the curved path may enable a haircare appliance which incorporates the heater assembly to have both a good ergonomic arrangement and a relatively compact arrangement. Specifically, it may be ergonomically advantageous for a haircare appliance to comprise a handle in which an inlet and relatively heavy components, such as an airflow generator, are located, and to comprise a curved portion to rotate the airflow path such that the airflow enters via the inlet and is emitted from an outlet in a direction orthogonal to a longitudinal axis of the handle. By arranging the frames, and thereby the resistive tracks, along the curved path, the heater assembly may be located within the curved portion and thereby provide a relatively compact and ergonomic arrangement.

Providing two resistive tracks may enabled greater flexibility in the design of the heater assembly and thereby the functionality of the heater assembly may be improved. For example, each resistive track may have a different geometry and thereby the geometry of each resistive track may be tailored to the specific flow pattern of the airflow at different points along the curved path. In another example, the geometry of each resistive track could be modified such that each resistive track operates at a different temperature, which may reduce the likelihood of the resistive tracks overheating and failing.

Additionally, having two resistive tracks and two associated frames, may enable each frame and resistive track to be formed separately and positioned independently along the curved path. This may make the heater assembly easier to manufacture than, for example a unitary curved frame and unitary resistive track.

In use, an airflow may be generated through the heater assembly and along the airflow path. The first and second resistive tracks may heat the airflow. Thereby, in the context of the present invention, upstream and downstream may be defined relative to the airflow through the heater assembly.

The first and second frames may define at least a portion of the airflow path.

The first resistive track may be defined between cut-outs in a first sheet, and the cut-outs may define the airflow path. The second resistive track may be defined between cut-outs in a second sheet, and the airflow path may extend through the cut-outs in the second sheet. Forming the resistive track from sheets may enable greater control over the geometry of the resistive tracks than, for example, may be achievable using wire. Greater control of the geometry of the resistive tracks may enable the functionality of the heater assembly to be improved. For example, the geometry of the resistive tracks may be designed to smooth the airflow or provide different amounts of heating at different locations along the curved path. Equally, the resistive tracks may be designed to incorporate projecting portions which project into the frames to support the resistive tracks. These projecting portions may replace separate support structures which may be more complicated to manufacture and more obstructive to the airflow. The cut-outs may be formed by etching or stamping.

The first frame may be spaced apart from the second frame along the curved path. Providing separate, spaced apart frames may improve the manufacturability of the heater assembly. Specifically, it may be simpler to manufacture two frames, each supporting a resistive track, and then arrange the frames along the curved path, than to manufacture a single curved frame which supports multiple tracks. The first and second frames may be separate components. The first frame may be spaced apart from the second frame by a spacer. Providing a spacer may increase the likelihood that a desired spacing is achieved whilst also improving the ease of assembly of the heater assembly.

The spacer may define the airflow path. As a result, the airflow which passes through the heater assembly may be constrained to the intended flow path by the spacer and frames. The spacer may comprise an aperture which defines the airflow path.

The first and second frames may each comprise an aperture which defines the airflow path; the curved path may extend through a centre point of each aperture; and a portion of the curved path which extends between the centre point of each aperture may subtend a central angle of no greater than 100 degrees. As a result, a relatively good ergonomic arrangement may be provided for the haircare appliance compared to an arrangement which subtended an angle of greater than 100 degrees.

The first and second frames may each comprise an aperture which defines the airflow path, the first frame may comprise an upstream face and a downstream face. A first plane may extend between and perpendicular to the upstream face and the downstream face, and may extend through a centre point of the aperture of the first frame. A portion of the first resistive track may be shaped such that, when viewed in the first plane, the portion of the first resistive track has a curved profile with a radius of curvature of no greater than 45 mm. In use, the resistive tracks may deflect due to the force of the airflow on the resistive tracks and the change in temperature of the resistive tracks. This deflection may result in adjacent resistive tracks contacting one another and shorting, which may result in a fault in the heater assembly. Therefore, by having a curved profile, this deflection may be controlled by shaping the resistive tracks such that the resistive tracks deflect in a known direction. This control of the deflection may improve the reliability and safety of the heater assembly by reducing the likelihood of the resistive tracks contacting one another and shorting. Having a radius of curvature of no greater than 45 mm may provide sufficient control of the deflection direction for the resistive tracks to be located relatively close together, which may improve the compactness of the heater assembly, compared to a heater assembly having resistive tracks having a greater radius of curvature.

A second plane may extend between and perpendicular to the upstream face of the first frame and the downstream face of the first frame, may extend perpendicular to the first plane, and may extend through the centre point of the aperture of the first frame. The portion of the first resistive track may be shaped such that, when viewed in the second plane, the portion of the first resistive track has a curved profile. Thereby the portion of the first resistive track may have a domed shape. When viewed in the second plane, the portion of the first resistive track may have a curved profile with a radius of curvature of no greater than 45 mm.

The second frame may comprise an upstream face and a downstream face. A third plane may extend between and perpendicular to the upstream face of the second frame and the downstream face of the second frame, and may extend through a centre point of the aperture of the second frame. A portion of the second resistive track may be shaped such that, when viewed in the third plane, the portion of the second resistive track has a curved profile with a radius of curvature of no greater than 45 mm.

A fourth plane may extend between and perpendicular to the upstream face of the second frame and the downstream face of the second frame, may extend perpendicular to the third plane, and may extends through the centre point of the aperture of the second frame. The portion of the second resistive track may be shaped such that, when viewed in the fourth plane, the portion of the second resistive track has a curved profile. When viewed in the fourth plane, the portion of the second resistive track may have a curved profile with a radius of curvature of no greater than 45 mm.

An apex of the portion of the first resistive track may be located no further downstream than the downstream face of the first frame, and the apex of the portion of the first resistive track may be located no further upstream than the upstream face of the first frame. As a result, the likelihood of the first resistive track being damaged during handling, e.g. during assembly, may be reduced as the first resistive track may be protected by the first frame.

An apex of the portion of the second resistive track may be located no further downstream than the downstream face of the second frame, and the apex of the portion of the second resistive track may be located no further upstream than the upstream face of the second frame.

An apex of the portion of the first resistive track may be located further downstream than a point at which the first resistive track is held by the first frame. This may aid in providing a relatively smooth airflow through the first resistive track.

An apex of the portion of the second resistive track may be located further downstream than a point at which the second resistive track is held by the second frame.

The apex of the portion of the first resistive track may be centred on the centre point of the aperture of the first frame. Thereby better control over the deflection of the segments of the first resistive track may be provided because a greater magnitude of deflection may be expected towards the centre point of the first resistive track. The apex of the portion of the second resistive track may be centred on the centre point of the aperture of the second frame.

The heater assembly may comprise a first bank and a second bank. The first bank may comprise a first plurality of resistive tracks including the first resistive track, and the second bank may comprise a second plurality of resistive tracks including the second resistive track. The first plurality of resistive tracks may be electrically connected in series with one another, and the second plurality of resistive tracks may be electrically connected in series with one another. Arranging the resistive tracks in banks and connecting the resistive tracks within a bank in series may reduce the amount of and simplify the wiring of the heater assembly compared to an arrangement of separate resistive tracks connected in parallel. This may reduce the cost and improve the manufacturability of the heater assembly.

The first bank may comprise a first temperature sensor for sensing a temperature of the first bank, and the second bank may comprise a second temperature sensor for sensing a temperature of the second bank. This may improve the responsiveness of the temperature sensors to changes in the temperature of the banks. Thereby, the fault detection responsiveness of the heater assembly may be improved compared to, for example, a heater assembly in which the heater assembly comprises only a single temperature sensor. Specifically, ingress of debris into the heater assembly may cause blockages in the airflow path which may result in localised overheating of the resistive tracks and/or single point failure of electrical components used to control the resistive tracks. By providing each bank with a dedicated temperature sensor, each temperature sensor may be located closer to the likely locations of blockages and thereby respond faster when a blockage occurs. This increased response time may result in the improved fault detection responsiveness, which may improve the safety of the heater assembly. Additionally, the temperature sensors may be more responsive to non-fault related changes in temperatures of the banks (e.g., as may occur if the temperature of the banks is being maintained at a set point temperature) which may result in the precision of temperature control of each bank being improved.

The heater assembly may comprise a controller for controlling a supply of electrical power to each of the banks based on a temperature sensed by the respective temperature sensor of each of the banks. Thereby, the granularity of control over the heating within the heater assembly may be improved. Additionally, the safety of the heater assembly may also be improved as, for example, the controller may turn off the supply of electrical power to a bank if the respective sensed temperature exceeds a safe operating threshold temperature.

The first bank and the second bank may each comprise only one temperature sensor. A single temperature sensor per bank may provide a good balance between the competing needs of improving the responsiveness of the heater assembly and reducing the cost and airflow obstruction entailed by additional temperature sensors.

The first temperature sensor may be located within the airflow path. As a result, the first temperature sensor may be more responsive to blockages in the airflow path than, for example, a temperature sensor not located in the airflow path. The second temperature sensor may be located within the airflow path.

The first temperature sensor may be located between two of the first plurality of resistive tracks of the first bank. Thereby the first temperature sensor is heated from two sides, when no airflow is present (for example, due to a blockage), which may improve the responsiveness of the first temperature sensor, for example in different orientations due to natural convection. The second temperature sensor may be located between two of the second plurality of resistive tracks of the second bank.

The first bank may comprise at least three resistive tracks, and a greater number of the resistive tracks of the first bank may be located upstream of the first temperature sensor than are located downstream of the first temperature sensor. Due to the passage of airflow through the heater assembly, the temperature sensor may be more able to sense the temperature of resistive tracks located upstream of the temperature sensor than resistive tracks located downstream of the temperature sensor. Therefore, by locating more of the resistive tracks upstream of the temperature sensor, the temperature sensor may be able to detect overheating of a greater number of the resistive tracks than if a greater number of resistive tracks were located downstream of the temperature sensor. Thereby, the fault detection responsiveness of the haircare appliance may be improved.

The second bank may comprise at least three resistive tracks, and a greater number of the resistive tracks of the second bank may be located upstream of the second temperature sensor than are located downstream of the second temperature sensor.

The first frame may comprise an outer wall section and an inner wall section. The outer wall section may be located further from a centre of curvature of the curved path than the inner wall section. The first temperature sensor may be located such that a distance between the outer wall section and the first temperature sensor is less than a distance between the inner wall section and the first temperature sensor. Due to the airflow following the curved path, the momentum of debris travelling through the heater assembly may cause the debris to collect predominantly against the outer wall section. Therefore, by locating the first temperature sensor relatively close to the outer wall section, the fault detection responsiveness of the first temperature sensor may be improved.

The second frame may comprise an outer wall section and an inner wall section. The outer wall section of the second frame may be located further from a centre of curvature of the curved path than the inner wall section of the second frame. The second temperature sensor may be located such that a distance between the outer wall section of the second frame and the second temperature sensor is less than a distance between the inner wall section of the second frame and the second temperature sensor.

The distance between the outer wall section of the first frame and the first temperature sensor may be no less than 14% of a distance between the outer wall section of the first frame and the inner wall section of the first frame. As a result, the first temperature sensor may be located relatively close to the centre point of the aperture of the first frame. Being located relatively close to the centre point of the aperture may result in the responsiveness of the first temperature sensor to non-fault related changes in the temperature of the first bank being improved. Specifically, the centre of the airflow, which passes through the centre point of the aperture, may change quicker when the temperature of the first bank changes than parts of the airflow located away from the centre point.

The distance between the outer wall section of the second frame and the second temperature sensor may be no less than 14% of a distance between the outer wall section of the second frame and the inner wall section of the second frame.

The distance between the outer wall section of the first frame and the first temperature sensor may be no greater than 31% of a distance between the outer wall section of the first frame and the inner wall section of the first frame. Being located relatively close to the outer wall may reduce the obstruction to the airflow presented by the first temperature sensor. Additionally, in examples where a portion of the first resistive track has a curved profile, being located relatively close to the outer wall may reduce the likelihood of the first temperature sensor contacting the segments of the first resistive track as they deflect. This may improve the safety of the heater assembly by reducing the likelihood of the first temperature sensor shorting with the first resistive track.

The distance between the outer wall section of the second frame and the second temperature sensor may be no greater than 31% of a distance between the outer wall section of the second frame and the inner wall section of the second frame.

The first resistive track may comprise a plurality of parallel linear segments, and a plurality of curved segments. Each curved segment may join one of the linear segments to an adjacent linear segment. This shape of resistive track may enable the first resistive track to be relatively robust during dynamic loading (e.g., if the heater assembly were dropped).

The second resistive track may comprise a plurality of parallel linear segments, and a plurality of curved segments. Each curved segment may join one of the linear segments to an adjacent linear segment.

The first resistive track may comprise a first segment and a second segment, and a cross section of the first segment may be different to a cross section of the second segment. As a result, the functionality of the first resistive track may be improved. For example, the area of each cross section may be different, which may result in the heating provided to the airflow by the resistive track (which is proportional to the area of each cross section) being varied across the first resistive track. In another example, the shape of each cross section may be different, which may enable the airflow to be manipulated differently at different locations across the first resistive track. This differing airflow manipulation may be used, for example, to produce a more uniform and/or even airflow.

The second resistive track may comprise a first segment and a second segment, and a cross section of the first segment may be different to a cross section of the second segment.

The heater assembly may comprise a housing and the housing may comprise a first part and a second part, which are attached to one another such that the first and the second frame are positioned within the housing. This ‘clam shell’ housing may enable the heater assembly to be relatively simply assembled. Additionally, it may be relatively simple to seal the housing and thereby reduce the likelihood of the airflow deviating from the intended airflow path.

The first part of the housing and the second part of the housing may comprise a plurality of recesses, and each of the recesses may be for receiving one of the first frame and the second frame. As a result, assembly of the heater assembly may be simplified because the frames may be retained by the recesses rather than additional fasteners or additional manufacturing steps e.g., an adhesive application step.

The heater assembly may comprise a spacer which spaces the first frame apart from the second frame along the curved path, and a clamp which applies a compressive force to secure the first frame and the second frame to the spacer. As a result, the components of the heater assembly may be held in place relative to one another.

The first frame may comprise an aperture which defines the airflow path, a first side which faces towards the airflow path, and a second side which faces away from the airflow path. The first resistive track may comprise electrically conductive tabs which extend through the first frame from the first side to the second side. As a result, the first resistive track may be connected to cabling or conductive strips for suppling electrical power to the first resistive track outside of the airflow path. Thereby, the airflow path may be unobstructed by cabling or conductive strips.

The second frame may comprise an aperture which defines the airflow path, a first side which faces towards the airflow path, and a second side which faces away from the airflow path. The second resistive track may comprise electrically conductive tabs which extend through the second frame from the first side to the second side.

According to a second aspect of the invention there is provided a haircare appliance comprising a heater assembly according to the first aspect of the invention.

According to a third aspect of the invention there is provided a heater assembly for a haircare appliance, the heater assembly comprising a frame and a resistive track. The frame comprises an aperture which defines an airflow path, an upstream face, and a downstream face. The resistive track is supported by the frame such that the resistive track is held within the airflow path. A plane extends between and perpendicular to the upstream face and the downstream face, and extends through a centre point of the aperture. A portion of the resistive track is shaped such that, when viewed in the plane the portion of the resistive track has a curved profile, and the section has a radius of curvature of no greater than 45 mm.

In use, the resistive track may deflect due to the force of the airflow on the resistive track and the change in temperature of the resistive track. This deflection may result in the resistive track contacting adjacent components of the heater assembly, which may result in a fault in the heater assembly. Therefore, by having a curved profile, this deflection may be controlled by shaping the resistive track such that the resistive track deflects in a known direction. This control of the deflection may improve the reliability and safety of the heater assembly by reducing the likelihood of the resistive track contacting an adjacent component. Having a radius of curvature of no greater than 45 mm may provide sufficient control of the deflection direction for the resistive track to be located relatively close to other components, such as other resistive tracks of the heater assembly, which may improve the compactness of the heater assembly, compared to a heater assembly having a resistive track having a greater radius of curvature.

The heater assembly according to the third aspect may comprise a second frame comprising an aperture which defines the airflow path, and a second resistive track supported by the second frame such that the second resistive track is held within the airflow path, wherein the frame and the second frame are arranged along a curved path. Arranging the frames, and thereby the resistive tracks, along the curved path may enable a haircare appliance which incorporates the heater assembly to have both a good ergonomic arrangement and a relatively compact arrangement. Specifically, it may be ergonomically advantageous for a haircare appliance to comprise a handle in which an inlet and relatively heavy components, such as an airflow generator, are located, and to comprise a curved portion to rotate the airflow path such that the airflow enters via the inlet and is emitted from an outlet in a direction orthogonal to a longitudinal axis of the handle. By arranging the frames, and thereby the resistive tracks, along the curved path, the heater assembly may be located within the curved portion and thereby provide a relatively compact and ergonomic arrangement.

Providing two resistive tracks may enabled greater flexibility in the design of the heater assembly and thereby the functionality of the heater assembly may be improved. For example, each resistive track may have a different geometry and thereby the geometry of each resistive track may be tailored to the specific flow pattern of the airflow at different points along the curved path. In another example, the geometry of each resistive track could be modified such that each resistive track operates at a different temperature, which may reduce the likelihood of the resistive tracks overheating and failing.

Additionally, having two resistive tracks and two associated frames, may enable each frame and resistive track to be formed separately and positioned independently along the curved path. This may make the heater assembly easier to manufacture than, for example a unitary curved frame and unitary resistive track.

According to a fourth aspect of the invention there is provided a heater assembly for a haircare appliance, the heater assembly comprising a first bank of resistive tracks, and a second bank of resistive tracks. The first bank of resistive tracks and the second bank of resistive tracks define an airflow path. The first bank of resistive tracks comprises a first plurality of resistive tracks held within the airflow path, and a first temperature sensor for sensing a temperature of the first bank of resistive tracks. The second bank of resistive tracks comprises a second plurality of resistive tracks held within the airflow path, and a second temperature sensor for sensing a temperature of the second bank of resistive tracks. The first plurality of resistive tracks are electrically connected in series with one another, and the second plurality of resistive tracks are electrically connected in series with one another.

Providing each bank with a dedicated temperature sensor may improve the responsiveness of the temperature sensors to changes in the temperature of the banks. Thereby, the fault detection responsiveness of the heater assembly may be improved compared to, for example, a heater assembly in which the heater assembly comprises only a single temperature sensor. Specifically, ingress of debris into the heater assembly may cause blockages in the airflow path which may result in localised overheating of the resistive tracks. By providing each bank with a dedicated temperature sensor, each temperature sensor may be located closer to the likely locations of blockages and thereby respond faster when a blockage occurs. This increased response time may result in the improved fault detection responsiveness, which may improve the safety of the heater assembly. Additionally, the temperature sensors may be more responsive to non-fault related changes in temperatures of the banks (e.g., as may occur if the temperature of the banks is being maintained at a set point temperature) which may result in the precision of temperature control of each bank being improved.

Arranging the resistive tracks in banks and connecting the resistive tracks within a bank in series may reduce the amount of and simplify the wiring of the heater assembly compared to an arrangement of separate resistive tracks connected in parallel. This may reduce the cost and improve the manufacturability of the heater assembly.

Providing multiple resistive tracks may enabled greater flexibility in the design of the heater assembly and thereby the functionality of the heater assembly may be improved. For example, each resistive track may have a different geometry and thereby the geometry of each resistive track may be tailored to the specific flow pattern of the airflow at different points along the airflow path. In another example, the geometry of each resistive track could be modified such that each resistive track operates at a different temperature, which may reduce the likelihood of the resistive tracks overheating and failing.

Optional features of the first resistive track or the second resistive track of the first aspect of the present invention may be equally applied to the resistive tracks of the first plurality of resistive tracks and the second plurality of resistive tracks, where appropriate.

The first bank may comprise a first plurality of frames and the second bank may comprise a second plurality of frames. Optional features of the first frame or the second frame of the first aspect of the present invention may be equally applied to the frames of the first plurality of frames and the second plurality of frames, where appropriate.

The first bank and the second bank may be arranged along a curved path. Arranging the banks along the curved path may enable a haircare appliance which incorporates the heater assembly to have both a good ergonomic arrangement and a relatively compact arrangement. Specifically, it may be ergonomically advantageous for a haircare appliance to comprise a handle in which an inlet and relatively heavy components, such as an airflow generator, are located, and to comprise a curved portion to rotate the airflow path such that the airflow enters via the inlet and is emitted from an outlet in a direction orthogonal to a longitudinal axis of the handle. By arranging the banks along the curved path, the heater assembly may be located within the curved portion and thereby provide a relatively compact and ergonomic arrangement.

Additionally, having multiple resistive tracks and multiple associated frames, may enable each frame and resistive track to be formed separately and positioned independently along the curved path. This may make the heater assembly easier to manufacture than, for example a unitary curved frame and unitary resistive track.

Optional features of aspects of the present invention may be equally applied to other aspects of the invention, where appropriate.

### BRIEF DESCRIPTION OF THE DRAWINGS

FIG. 1 is a schematic view of a haircare appliance according to the present invention;

FIG. 2 is a view of a heater assembly of the haircare appliance of FIG. 1;

FIG. 3 is a view of the heater assembly of FIG. 2 with additional components show;

FIG. 4 is a view of a section through the heater assembly of FIG. 3;

FIG. 5 is an exploded view of a bank of resistive tracks of the heater assembly of FIG. 2;

FIG. 6 is a view of a resistive track supporting frame of the bank of resistive tracks of FIG. 5;

FIG. 7 is a view of a temperature sensor supporting frame of the bank of resistive tracks of FIG. 5;

FIG. 8 is an unexploded view of the bank of resistive tracks of FIG. 5;

FIG. 9 is a view of a section through a resistive track and resistive track supporting frame of the bank of FIG. 6;

FIG. 10 is a view of a spacer of the heater assembly of FIG. 2;

FIG. 11 is a view of a clamp of the heater assembly of FIG. 2;

FIG. 12 is a block diagram of electrical components of the heater assembly of FIG. 2;

FIG. 13 is a view of an alternative resistive track;

FIG. 14 is a view of an alternative heater assembly; and

FIG. 15 is a view of a section of a part of a housing of the alternative heater assembly of FIG. 14.

### DETAILED DESCRIPTION OF THE INVENTION

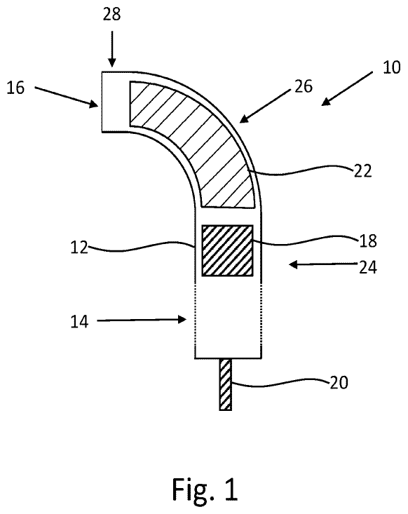

A haircare appliance 10 according to the present invention is illustrated schematically in FIG. 1. The haircare appliance 10 comprises a main body 12, an air inlet 14, an air outlet 16, an airflow generator 18, a power cable 20 and a heater assembly 22.

The main body 12 comprises a handle portion 24, a curved portion 26, and an outlet portion 28. The handle portion 24 is generally straight and cylindrical in form, and is intended to be grasped by a user in use. The air inlet 14 is located at an end of the handle portion 24, and comprises a plurality of apertures formed in the handle portion 24. The handle portion 24 houses the airflow generator 18.

The curved portion 26 extends between the handle portion 24 and the outlet portion 28, and turns through around 90° from the handle portion 26 to the outlet portion 28. The heater assembly 22 is located inside the curved portion 26.

The outlet portion 28 is generally straight, cylindrical and hollow in form. The air outlet 16 is a generally circular aperture formed at the end of the outlet portion 28.

The airflow generator 18 generates an airflow from the air inlet 14 to the air outlet 16, through the handle portion 24, the heater assembly 22 and the outlet portion 28, in use. The airflow generator 18 typically comprises a motor-driven impeller.

The power cable 20 connects to a main power supply to supply electrical power to the other electrical components of the haircare appliance 10, such as the heater assembly 22. In other examples, the power cable 20 may be replaced by a power supply comprising a battery supplying a DC voltage.

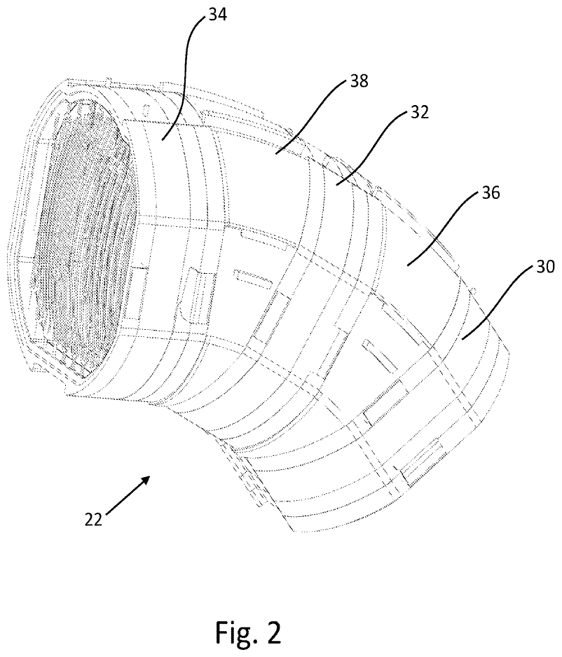

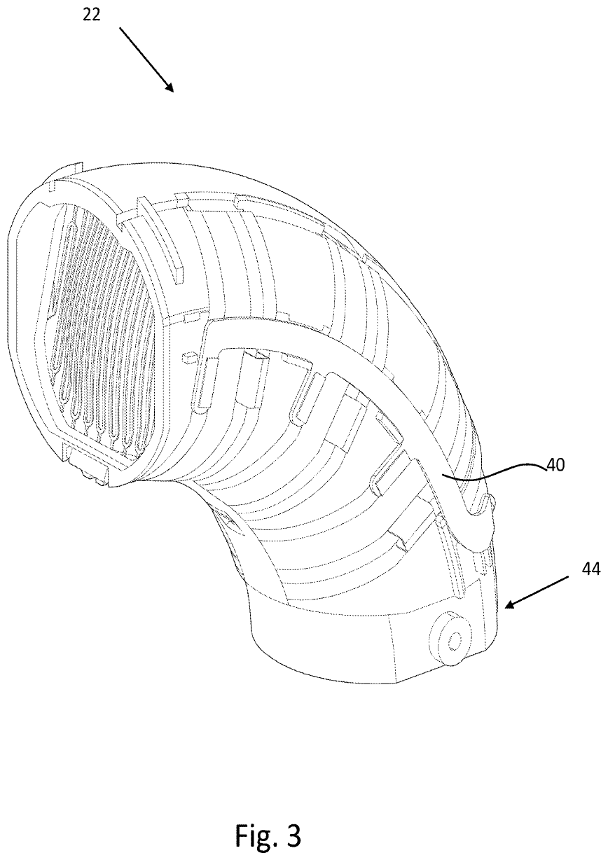

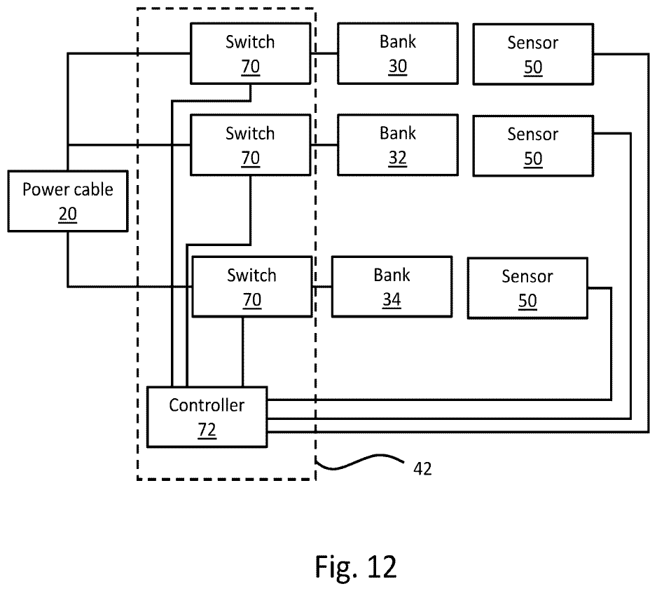

Turning now to FIGS. 2 to 4, the heater assembly comprises a first 30, second 32 and third 34 bank; a first 36 and second 38 spacer; electrical looming 40; a control unit 42 (which is shown in FIG. 12); and a clamp 44. The heater assembly 22 defines a flow path which extends between an upstream end of the heater assembly 22 to a downstream end of the heater assembly 22.

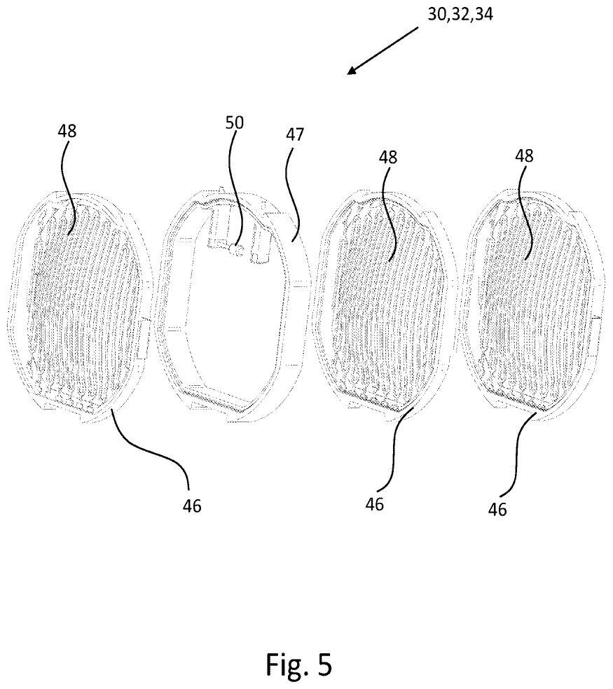

Turning now to FIG. 5, each of the banks 30,32,34 comprises three resistive track supporting frames 46, a temperature sensor supporting frame 47, three resistive tracks 48 and a temperature sensor 50. In other examples, each bank 30,32,34 may comprise a different number of frames 46,47 and associated resistive tracks 48 and temperature sensors 50.

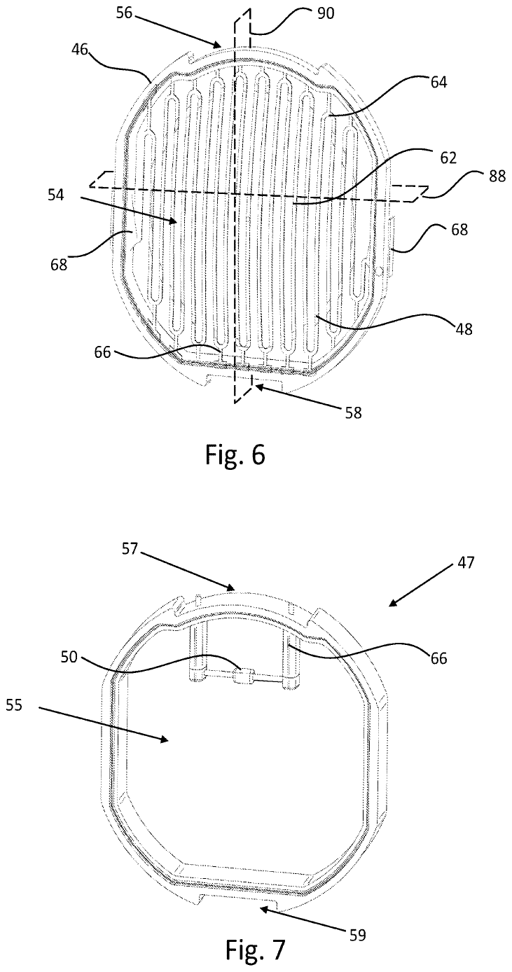

Turning now to FIG. 6, each of the resistive track supporting frames 46 is generally annular in form and thereby comprises an aperture 54. The aperture 54 defines a portion of the flow path. Each frame 46 is shaped such that a top channel 56 is defined by the top of the frame, and a bottom channel 58 is defined by the bottom of the frame. The channels 56,58 are defined on the side of each frame 46 which faces away from the aperture 54. As will be described in more detail below, each of the resistive track supporting frames 46 supports one of the resistive tracks 48.

Turning now to FIG. 7, the temperature sensor supporting frame 47 is generally annular in form and thereby comprises an aperture 55 and two support members 60. The aperture 55 defines a portion of the flow path. The frame 47 is shaped such that a top channel 57 is defined by the top of the frame 47, and a bottom channel 59 is defined by the bottom of the frame 47. The channels 57,59 are defined by the side of the frame 47 which faces away from the aperture 55.

The support members 60 are spaced apart from one another and extend from a top of the frame 47 into the aperture 54. The temperature sensor 50 extends between the distal ends of the support members 60 such that the frame 47 supports the temperature sensor 50.

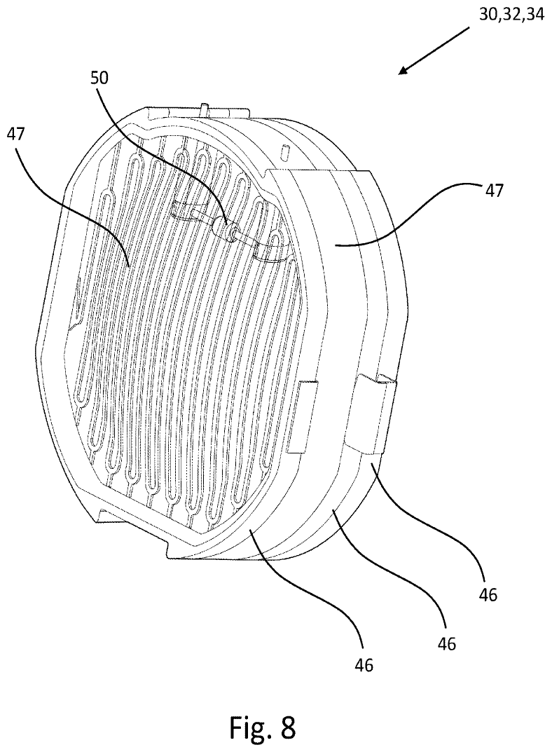

Turning now to FIG. 8, when the bank 30,32,34 is assembled, the frames 46,47 abut one another such that the bank 30,32,34 has a generally tubular shape. The frames 46,47 are arranged such that two of the resistive track supporting frames 46 are located upstream of the temperature sensor supporting frame 47. The third resistive track supporting frame 46 is located downstream of the temperature sensor supporting frame 46. Thereby, the temperature sensor 50 is located between two of the resistive tracks 48 of the bank 30,32,34 and a greater number of the resistive tracks 48 of the bank 30,32,34 are located upstream of the temperature sensor 50 than are located downstream of the temperature sensor 50. Additionally, the frames 46,47 are orientated such that the top channels 56,57 align with one another and the bottom channels 58,59 align with one another.

Returning to FIG. 6, each resistive track 48 extends across the aperture 54 of a respective resistive track supporting frame 46 and thereby extends across the portion of the flow path defined by the respective frame 46. Each resistive track 48 comprises a plurality of parallel linear segments 62, a plurality of curved segments 64, a plurality of projecting portions 66, and two electrically conductive tabs 68. The curved segments 64 curve through approximately 180 degrees and connect one of the linear segments 62 to an adjacent linear segment 62 such that the resistive track 48 has a generally serpentine shape.

Each projecting portion 66 projects from one of the curved segments 64 into the respective frame 46 such that the resistive track 48 is supported by the respective frame 46. Thereby, the resistive track 48 is held within the flow path by the respective frame 46.

Each of the electrically conductive tabs 68 forms an end portion of the resistive track 48 and extend through the respective frame 46 from a first side of the frame 46 which faces the aperture 54 (and thereby the flow path) of the respective frame 46 to a second side of the frame 46 which faces away from the aperture 54 of the respective frame 46. A portion of each tab 68 extends from the second side and is connected to the electrical looming 40.

In this example, each resistive track 48 is formed from a sheet by etching such that the resistive track 48 is defined between cut-outs in the sheet. The airflow path is defined by the cut-outs in the sheet such that the airflow passes through the cut-outs in use. Equally, the resistive tracks 48 may be formed by other processes such as stamping.

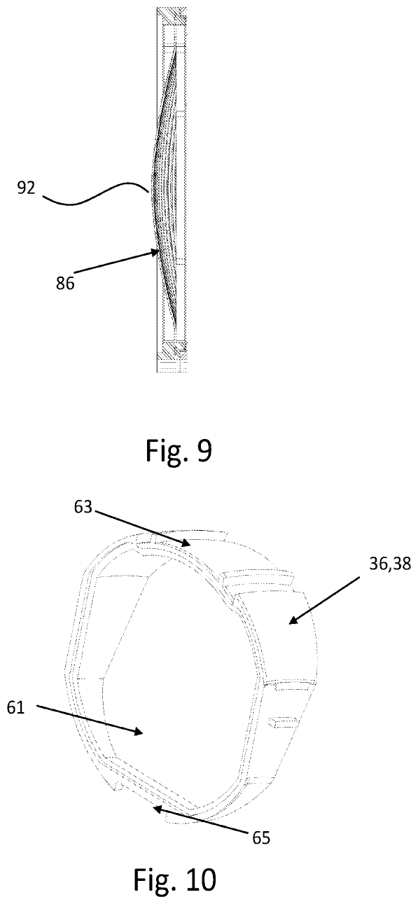

A first plane 88 extends between an upstream face and a downstream face of each of the resistive track supporting frames 46. The first plane 88 also extends through the centre point of the aperture 54 of the frame 46. As shown in FIG. 9, when viewed in the first plane 88, the portion 86 of the resistive track 48 has a curved profile with a radius of curvature of no greater than 45 mm.

A second plane 90 extends between and perpendicular to the upstream face and the downstream face of each of the resistive track supporting frames 46. Additionally, the second plane 90 extends perpendicular to the first plane 88 and extends through the centre point of the aperture 54 of the frame 46. The portion 86 of the resistive track 48 is shaped such that, when viewed in the second plane 90, the portion 86 of the resistive track 48 has a curved profile with a radius of curvature of no greater than 45 mm.

The resistive track supporting frames 46 are arranged within each bank 30,32,34 such that an apex 92 of the portion 86 of each of the resistive track 48 is located further downstream than the points at which the projecting portions 66 project into the frame 46. I.e., the points at which the resistive track 48 is held by the frame 46. The portion 86 is sized such that the apex 92 is located no further downstream than the downstream face of the frame 46. I.e., the upper bound of the radius of curvature of the curved profile is dictated by the distance between the upstream face and the downstream face (the depth) of the frame 46. Additionally, the apex 92 of the portion 86 of the resistive track 48 is centred on the centre point of the aperture 54 of the frame 46. In this example, only the linear segments 62 of the resistive track 48 are part of the portion 86. However, in other examples the portion 85 may comprise a greater or a less proportion of the resistive track 48. For example, the entire resistive track 48, including the curved segments 64 and the projecting portions 66 may form part of the portion 86.

The temperature sensor 50 extends between the support members 60 of the temperature sensor supporting frame 47 such that the temperature sensor 50 is located within the aperture 55 of the frame 47 and is thereby located within the airflow path. The temperature sensor 50 is electrically connected to wiring which extends from the temperature sensor 50, through the support members 60 and connects to the electrical looming 40. The temperature sensor 50 senses a temperature of the bank 30,32,34.

Turning now to FIG. 10, each spacer 36,38 has a generally cylindrical tubular shape which curves along its length. Thereby, each spacer 36,38 defines an aperture 61 which defines a portion of the airflow. Each spacer 36,38 is shaped such that a top channel 63 is defined by the top of each spacer 36,38, and a bottom channel 65 is defined by the bottom of each spacer 36,38. The channels 63,65 are defined by the side of each spacer 36,38 which faces away from the aperture 61.

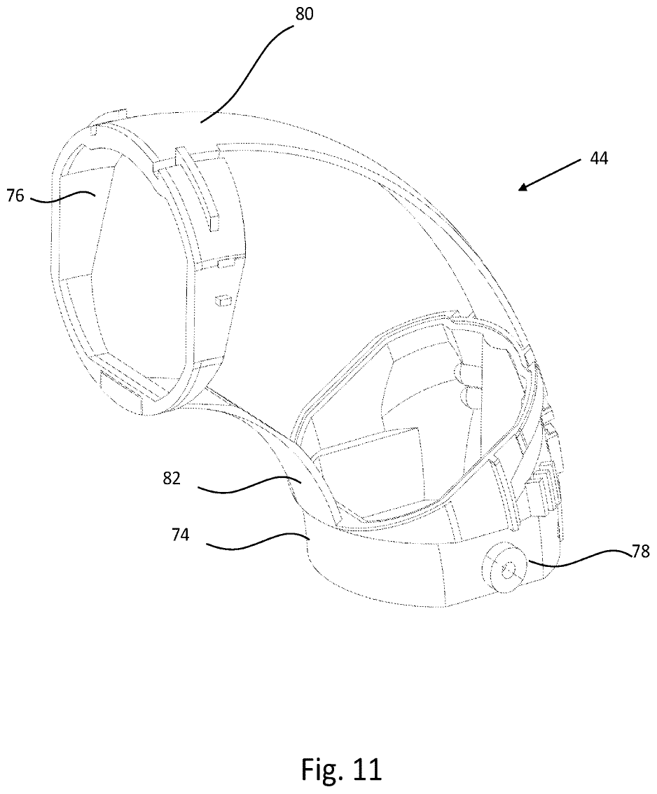

The clamp 44 (shown in FIG. 11) comprises a lower piece 74 and an upper piece 76. The lower piece 74 comprises a main body 78, an upper arm 80 and a lower arm 82. The main body 78 has a generally hollow cylindrical shape. The upper 80 and lower 82 arms each project in a generally downstream direction from opposite sides of the main body 78 and have a generally curved, elongated shape. Each arm comprises a clip at a distal end.

The upper piece 76 has a generally cylindrical tubular shape which curves along its length. Thereby the upper piece 76 defines an aperture. The upper piece 76 is shaped such that a top channel is defined by the top of the upper piece 76 and a bottom channel is defined by the bottom of the upper piece 76. The channels are defined by the side of the upper piece 76 which faces away from the aperture of the upper piece 76. Each channel comprises a clip receiving feature for each of the clips of the arms 78,80 of the clamp 44 to clip to.

To assemble the heater assembly 22, a downstream end of the first bank 30 is abutted with the lower piece 74 of the clamp 44. The first bank 30 is orientated such that the upper arm 80 extends through the top channels 56,57, and the lower arm 82 extends through the bottom channels 58,59 of the frames 46,47 of the first bank 30. The interaction of the arms 80,82 and channels 56,57,58,59 may aid in orientating and securing the first bank 30 to the lower piece 78 of the clamp 44. The downstream end of the first spacer 36 is then abutted with the upstream end of the first bank 30. In a similar manner to the first bank 30, the first spacer 36 is orientated such that the upper arm 80 extends through the top channel 63, and the lower arm 82 extends through the bottom channel 65. The downstream end of the second bank 32 is then abutted with the upstream end of the first spacer 36. This process is then repeated for the second spacer 38 and then the third bank 34. A downstream end of the upper part 76 of the clamp 44 is then abutted with an upstream end of the third bank 34 and the clips of the arms 80,82 are then clip to the clip receiving features of the upper part of the clamp 76. Thereby, a compressive force is applied by the clamp 44 to the heater assembly 22 to clamp the heater assembly 22 together.

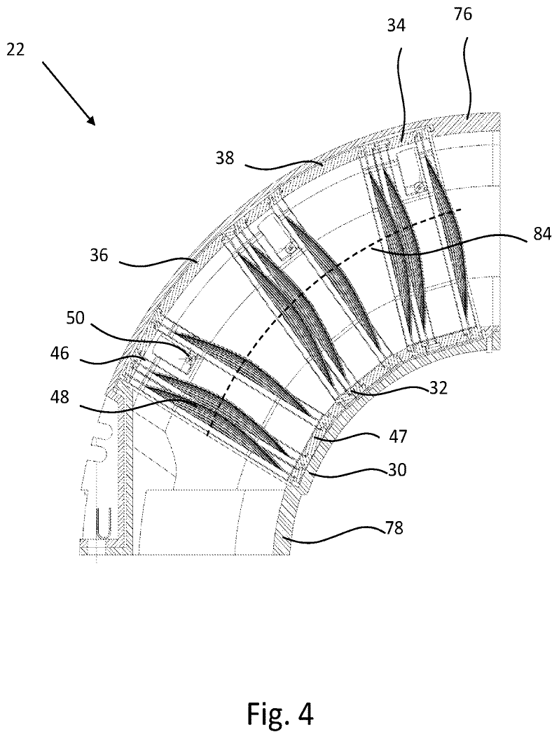

As shown in FIG. 4, when assembled, the banks 30,32,34 (and thereby the frames of the banks) are arranged along a curved path 84 such that the airflow exits the upper part of the heater assembly 22 in a direction substantially orthogonal to the direction in which airflow enters the lower part of the heater assembly 22. The curved path 84 is an imaginary line which extends through the centre point of each aperture 54,55,61 of the frames 46,47 and spacers 36,38. In this example, the arrangement of the frames 46,47 along the curved path 84 is provided by the shape of the spacers 36,38 which results in the frames 46,47 of each bank 30,32,34 being inclined to the frames 46,47 of the other banks 30,32,34. However, as will be discussed below, the arrangement of the frames 46,47 along the curved path 84 may be provided by means other than the spacers 36,38. In this example, the portion of the flow path defined by each individual bank 30,32,34 or spacer 30,32 may be straight. Therefore, in this example, the curved path 84 is formed by multiple straight portions which are inclined to one other to form an overall curved path 84.

Arranging the frames 46,47, and thereby the resistive tracks 48, along the curved path 84 may enable a haircare appliance 10 which incorporates the heater assembly 22 to have both a good ergonomic arrangement and a relatively compact arrangement. Specifically, it may be ergonomically advantageous for a haircare appliance 10 to comprise the handle 24 in which the inlet 14 and relatively heavy components, such as an airflow generator 18, are located, and to comprise a curved portion 26 to rotate the airflow such that the airflow enters via the inlet 14 and is emitted from the outlet 16 in a direction orthogonal to a longitudinal axis of the handle 24. By arranging the frames 46,47, and thereby the resistive tracks 48, along the curved path 84, the heater assembly 22 may be located within the curved portion 26 and thereby provide a relatively compact and ergonomic arrangement.

Providing multiple resistive tracks 48 may enabled greater flexibility in the design of the heater assembly 22 and thereby the functionality of the heater assembly 22 may be improved. For example, each resistive track 48 may have a different geometry and thereby the geometry of each resistive track 48 may be tailored to the specific flow pattern of the airflow at different points along the curved path 84. In another example, the geometry of each resistive track 48 could be modified such that each resistive track 48 operates at a different temperature, which may reduce the likelihood of the resistive tracks 48 overheating and failing.

Additionally, having multiple resistive tracks 48 and multiple associated frames 46, may enable each frame 46 and resistive track 48 to be formed separately and positioned independently along the curved path 84. This may make the heater assembly 22 easier to manufacture than, for example a unitary curved frame and unitary resistive track.

Turning now to FIG. 12, the control unit 42 comprises a set of switches 70 and a controller 72.

Each of the switches 70 is connected between the power cable 20 and one of the banks 30,32,34 by the electrical looming 40. Accordingly, when one of the switches 70 is closed, electrical power is supplied to an associated bank 30,32,34. Conversely, when the switch 70 is open, the supply of electrical power to the bank 30,32,34 is halted.

The controller 72 is connected to the airflow generator 18 and the switches 70. Additionally, the controller 72 is connected to the temperature sensors 50. As a result, the controller 72 is provided with a sensed temperature of each of the banks 30,32,34. The controller 72 is responsible for controlling the operation of haircare appliance 10. In particular, the controller 72 controls the opening and closing of the switches 70 and thus the electrical power supplied to the banks 30,32,34, in response to the sensed temperature of each bank 30,32,34 provided by the temperature sensors 50. For example, the controller 72 may control the switches 70 such that the temperature of each bank 30,32,34, as sensed by the respective temperature sensor 50, is maintained at a particular setpoint. Additionally, the controller 72 may open one of the switches 70 to halt the supply of power to a bank 30,32,34 if the sensed temperature of that bank 30,32,34 exceeds a safe operating threshold. The controller 72 also controls the operation of the airflow generator 18.

In use, the airflow generated by the airflow generator 18 enters the heater assembly 22 at the downstream end of the lower part 78 of the clamp 44 and then follows the airflow path through the heater assembly 22 to exit at the upstream end of the upper part 76 of the clamp 44. During normal operation of the heater assembly, the switches 70 are closed, and electrical power is supplied to the banks 30,32,34. Accordingly, the resistive tracks 48 heat the airflow as the airflow passes through the heater assembly 22. During operation, debris may build up inside the heater assembly 22. This debris may form a blockage to the airflow which may cause the temperature of one of the banks 30,32,34 to increase excessively. In this event, the controller 72 will detect the fault due to the sensed temperature of the bank 30,32,34 exceeding the safe operating threshold and the controller 72 then opens the associated switch 70 to halt the supply of power to the bank 30,32,34.

Due to the arrangement of the heater assembly 22, the top of each of the temperature sensor supporting frames 47 is located further from a centre of curvature of the curved path 84 than the bottom of each of the frames 47. Accordingly, it could be said that each of the temperature sensor supporting frames 47 comprises an outer wall section (the top of the frame 47) an inner wall section (the bottom of the frame 47). The heights of the support members 60 of the support frame 47 are such that a distance between the outer wall section and the temperature sensor 50 is 20% of a distance between the outer wall section and the inner wall section (i.e., the width of the aperture 54 of the frame 46,47). Equally, in other examples the height of the support members 60 may be such that other distances are used.

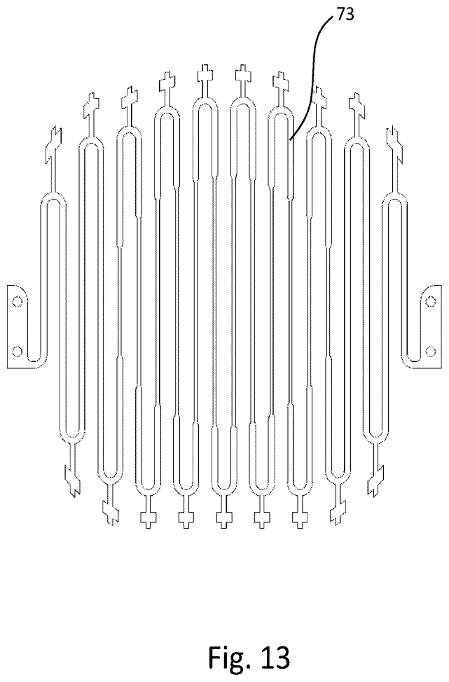

The airflow profile may not be the same across the width of the aperture 54 of each frame 46. For example, the velocity of the airflow may vary across the width of the aperture 54. To compensate for this difference, different segments of each resistive track 48 may have different cross sections. For example, FIG. 13 shows an alternative resistive track 73 in which the cross-sectional area and the geometry of segments of the resistive track 73 located towards the centre-point of each aperture 54 is different to segments located further from the centre-point of the aperture 54.

The portion of the curved path 84 which extends between the centre point of the aperture 54 of the most downstream frame 46,47 and the centre point of the aperture 54 of the most upstream frame 46,47 subtends a central angle of approximately 80 degrees. In other examples, the portion of the curved path 84 may subtend other angles.

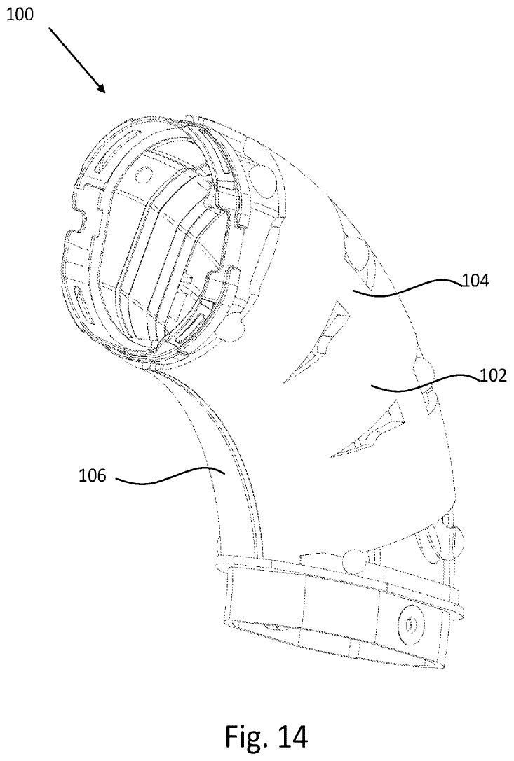

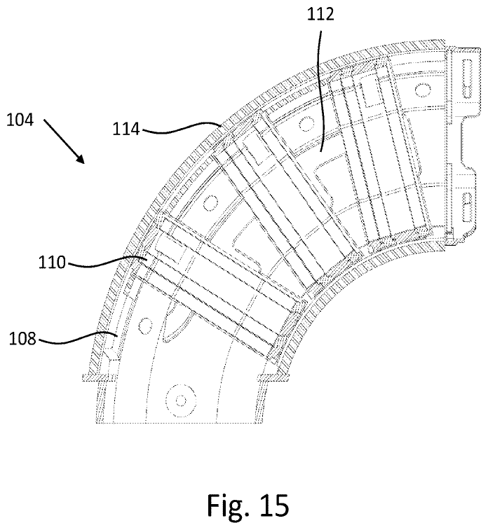

In the above example, the arrangement of the frames 46,47 along the curved path 84 is provided by the shape of the spacers 36,38 which results in the frames 46,47 of each bank 30,32,34 being inclined to the frames 46,47 of the other banks 30,32,34. However, the arrangement of the frames 46,47 along the curved path 84 may be provided by means other than the spacers 36,38. For example, FIGS. 14 and 15 show an alternative heater assembly 100.

The alternative heater assembly 100 is identical to the heater assembly 22 described above but with the following exceptions. Firstly, the spacers 36,38 are omitted. Secondly, the clamp 44 is replaced with a housing 102. The housing 102 comprises a first part 104 and a second part 106.

Turning now to FIG. 15, each part of the housing 104,106 comprises a main body 108, a plurality of recesses 110,112 and a mating interface 114. The main body 108 has a C shaped section and curves along its length through approximately 90 degrees. Each recess 110,112 is located in a concave side of the main body 108. Three of the recesses 110 are each sized to receive half of one of the banks 30,32,34 and are located relative to one another such that when the banks 30,32,34 are inserted into the recesses, the banks 30,32,34 are arranged along the curved path 84. A fourth recess 112 is sized to receive the electrical looming 40. The mating interface 114 is provided along the ends of the C shaped cross section and interfaces with a corresponding interface on the second part 106 of the housing 102 to attach the parts 104,106 together.

To assembly the alternative heating assembly 100, each bank 30,32,34 is placed in one of the recesses 110, and the two parts 104,106 of the housing 102 are brought together such that the mating interfaces 114 interface to attach the first part 104 to the second part 106 and hold the banks 30,32,34 in place. When assembled the housing 102 has a generally cylindrical tubular shape which curves through approximately 90 degrees along its length. A seal is additionally provided along the join line between the first part 104 and the second part 106.

Whilst particular examples and embodiments have thus far been described, it should be understood that these are illustrative only and that various modifications may be made without departing from the scope of the invention as defined by the claims.

1. A heater assembly for a haircare appliance, the heater assembly comprising:
first and second frames arranged along a curved path to define an airflow path;
a first resistive track supported by the first frame such that the first resistive track is held within the airflow path; and
a second resistive track supported by the second frame such that the second resistive track is held within the airflow path.

2. The heater assembly as claimed in claim 1, wherein one or more of:
the first frame is spaced apart from the second frame along the curved path;
the first frame is spaced apart from the second frame by a spacer, and
the spacer defines a portion of the airflow path.

3. (canceled)

4. (canceled)

5. The heater assembly as claimed in claim 1, wherein:
the first and second frames each comprise an aperture which defines the airflow path;
the curved path extends through a centre point of each aperture; and
a portion of the curved path which extends between the centre point of each aperture subtends a central angle of no greater than 100 degrees.

6. The heater assembly as claimed in claim 1, wherein:
the first and second frames each comprise an aperture which defines the airflow path;
the first frame comprises an upstream face and a downstream face;
a first plane:
extends between and perpendicular to the upstream face and the downstream face; and
extends through a centre point of the aperture of the first frame; and
a portion of the first resistive track is shaped such that, when viewed in the first plane, the portion of the first resistive track has a curved profile with a radius of curvature of no greater than 45 mm.

7. The heater assembly as claimed in claim 6, wherein:
a second plane:
extends between and perpendicular to the upstream face and the downstream face;
extends perpendicular to the first plane; and
extends through the centre point of the aperture of the first frame; and
the portion of the first resistive track is shaped such that, when viewed in the second plane, the portion of the first resistive track has a curved profile.

8. The heater assembly as claimed in claim 6, wherein:
an apex of the portion of the first resistive track is located no further downstream than the downstream face; and
the apex of the portion of the first resistive track is located no further upstream than the upstream face.

9. The heater assembly as claimed in claim 6, wherein an apex of the portion of the first resistive track is located further downstream than a point at which the first resistive track is held by the first frame.

10. The heater assembly as claimed in claim 6, wherein an apex of the portion of the first resistive track is centred on the centre point of the aperture of the first frame.

11. The heater assembly as claimed in claim 1, wherein:
the heater assembly comprises a first bank and a second bank;
the first bank comprising a first plurality of resistive tracks including the first resistive track, and the second bank comprising a second plurality of resistive tracks including the second resistive track; and
the first plurality of resistive tracks are electrically connected in series with one another, and the second plurality of resistive tracks are electrically connected in series with one another.

12. The heater assembly as claimed in claim 11, wherein:
the first bank comprises a first temperature sensor for sensing a temperature of the first bank; and
the second bank comprises a second temperature sensor for sensing a temperature of the second bank;
wherein optionally the first temperature sensor is located within the airflow path, and/or wherein the first temperature sensor is located between two of the first plurality of resistive tracks of the first bank.

13. (canceled)

14. (canceled)

15. The heater assembly as claimed in claim 12, wherein:
the first bank comprises at least three resistive tracks; and
a greater number of the resistive tracks of the first bank are located upstream of the first temperature sensor than are located downstream of the first temperature sensor.

16. The heater assembly as claimed in claim 12, wherein:
the first frame comprises an outer wall section and an inner wall section;
the outer wall section is located further from a centre of curvature of the curved path than the inner wall section;
the first temperature sensor is located such that a distance between the outer wall section and the first temperature sensor is less than a distance between the inner wall section and the first temperature sensor.

17. The heater assembly as claimed in claim 16, wherein the distance between the outer wall section and the first temperature sensor is no less than 14% of a distance between the outer wall section and the inner wall section.

18. The heater assembly as claimed in claim 16, wherein the distance between the outer wall section and the first temperature sensor is no greater than 31% of a distance between the outer wall section and the inner wall section.

19. The heater assembly as claimed in claim 1, wherein the first resistive track comprises:
a plurality of parallel linear segments; and
a plurality of curved segments, each curved segment joining one of the linear segments to an adjacent linear segment.

20. The heater assembly as claimed in claim 1, wherein:
the first resistive track comprises a first segment and a second segment; and
a cross section of the first segment is different to a cross section of the second segment.

21. The heater assembly as claimed in claim 1, wherein:
the heater assembly comprises a housing; and
the housing comprises a first part and a second part, which are attached to one another such that the first frame and the second frame are positioned within the housing.

22. The heater assembly as claimed in claim 1, wherein the heater assembly comprises:
a spacer which spaces the first frame apart from the second frame along the curved path; and
a clamp which applies a compressive force to secure the first frame and the second frame to the spacer.

23. The heater assembly as claimed in claim 1, wherein:
the first frame comprises:
an aperture which defines the airflow path;
a first side which faces towards the airflow path; and
a second side which faces away from the airflow path; and
the first resistive track comprises electrically conductive tabs which extend through the first frame from the first side to the second side.

24. A haircare appliance comprising a heater assembly as claimed in claim 1.
